(19) United States
(12) Patent Application Publication
(10) Pub. No.: US 2025/0082127 A1
(43) Pub. Date: Mar. 13, 2025

(54) MACHINE FOR PREPARING AND EXTRACTING A HOT BEVERAGE

(71) Applicant: GISE CAFFE' S.R.L., Gaggio Montano (Bologna) (IT)

(72) Inventor: Giovanni ACCURSI, Alto Reno Terme (Bologna) (IT)

(21) Appl. No.: 18/720,392

(22) PCT Filed: Dec. 14, 2022
(86) PCT No.: PCT/IB2022/062204

§ 371 Date: Jun. 14, 2024

(30) Foreign Application Priority Data
Dec. 17, 2021 (IT) 102021000031661

(51) Int. Cl. A47J 31/36; A47J 31/06; A47J 31/44

(52) U.S. Cl. CPC A47J 31/3633; A47J 31/0668; A47J 31/3638; A47J 31/4403

(57) ABSTRACT

A machine for preparing/extracting a hot beverage from a capsule includes a second movable extraction unit, positioned in a frame, and movable along a linear trajectory, between a first non-operating position, wherein the second unit is positioned close to an inlet opening, and a second operating position wherein the second unit is moved towards a first fixed extraction unit to move the capsule inside a housing and a pair of supporting arms interposed between the second unit and the frame; each arm is articulated, in a relative articulation zone, to the second unit provided with a matching seat; each articulation zone of each arm can rotate about an axis and includes two different contact heads protruding from the second unit and configured to interact with tracks having cam profiles of the frame to move each arm between two positions, during movement of the second unit.

### TECHNICAL FIELD

This invention relates to a machine for preparing and extracting a hot beverage.

### BACKGROUND ART

The machine according to the invention is of the type using single capsules, preferably of the single-dose type, from which the hot beverage is extracted (such as coffee, tea, milk, camomile and similar beverages) by extracting the product with pressurised hot fluid.

The capsules used for this type of machine basically comprise a capsule body forming a chamber having a bottom and an opening of the capsule body delimited by an annular collar protruding transversally with respect to the body.

A dose of extraction product is housed in the chamber.

The opening of the capsule is sealed by a piece of film adherent to the annular collar.

The prior art machines using these capsules basically comprise:
a load-bearing frame having an inlet opening for the capsule;
a first fixed extraction unit positioned in the load-bearing frame and comprising a housing for the capsule and means for perforating and passage of the mixture, to obtain the extraction of the beverage, positioned on the bottom of the housing;
a second movable extraction unit, positioned inside the frame, and movable inside the frame along a linear trajectory, in both directions, between a first non-operating end position away from the first fixed extraction unit (wherein the second movable extraction unit is positioned close to the inlet opening), and a second operating end position wherein the second movable extraction unit is moved towards the first fixed extraction unit in such a way as to move the capsule from an inlet position in the frame to a housing position in the first fixed unit for extracting the beverage by feeding a pressurised hot fluid.

Means for supporting the capsule are interposed between the movable extraction unit and the frame.

Usually, these supporting means may comprise a pair of protruding arms, positioned on both sides of the movable extraction unit, configured to retain the capsule entering (by falling) from the opening present on the frame. The pair of arms is configured to move along the frame synchronised with the movable extraction unit. These arms can move between a first operating position, with the ends of the arms positioned at a reciprocal reduced distance, for retaining the capsule (with the extraction unit movable in the first non-operating position), to a second non-operating position, wherein the ends of the arms are at a mutual distance greater than the previous distance so as to free the capsule at the housing of the capsule in the fixed dispensing extraction unit (with the movable extraction unit in the second operating position).

The movable extraction unit has a head provided with perforating elements which are able to perforate, according to a first solution, the sheet of film (if the capsule is inserted in the frame with the bottom facing towards the fixed extraction unit) or, according to a second solution, the perforating elements perforate the bottom of the capsule (if the capsule is inserted in the frame in the opposite direction to the previous one).

The head of the movable extraction unit is provided with ducts for the passage of the pressurised hot fluid to be introduced into the capsule after the capsule has been perforated.

The extraction of the beverage occurs by the combination given by the increase in the pressure inside the capsule supplied by the fluid entering and by the presence of the perforating means positioned on the bottom of the housing of the first fixed extraction unit which allow an opening in the capsule to be obtained for the passage of the beverage obtained from the product/fluid mixture towards the dispensing conduits of the extracted beverage made in the first fixed extraction unit.

The means for supporting the capsule, of particular interest for the invention, comprise the above-mentioned pair of arms interposed between the second movable extraction unit and the walls of the frame.

Each arm has a first end retained between the frame and the second movable extraction unit and configured for moving the arm between the first and second operating and non-operating positions and, at the same time, each end is pulled, by pushing/traction means made on the outer surface of the second movable extraction unit, for moving with the second movable extraction unit.

The free end of each arm is provided with a protrusion for retaining the capsule at a zone of its collar.

The protrusion is positioned transversal to the extension of the arm and defined by a pair of parallel tabs spaced from each other to define an area for coupling with the zone of the collar.

Solutions of arms of this type are known from US documents 2016/309945 and US 2010/224077. According to these solutions, the arms are provided with heads for constraining to cam surfaces obtained on the machine frame and are guided during the forward movement and withdrawal by means of horizontal pushing and pulling walls protruding transversally relative to the second movable extraction unit.

These structures for moving and controlling the positions which can be adopted by the two arms have several drawbacks.

The interposing of the ends of the arms between the surfaces of the frame and the surfaces of the second movable extraction unit may create, with use over time, a high level of wear of both the arms and the surfaces of the frame so as to worsen both the movement of the arms and their positioning precision with negative effects on the operation of the machine as a whole.

### Aim of the Invention

The aim of this invention is to provide a machine for preparing and extracting a hot beverage that overcomes the above-mentioned drawbacks of the prior art.

In particular, the aim of the invention is to provide a machine for preparing and extracting a hot beverage which is able to obtain a high precision in positioning the arms together with a long service life.

A further aim of the invention is to provide a machine for preparing and extracting a hot beverage which is able to also obtain, with the same pair of arms, the final step of extracting and falling of the used capsule.

Said aims are fully achieved by the machine for preparing and extracting a hot beverage according to the invention as characterised in the appended claims.

### BRIEF DESCRIPTION OF THE DRAWINGS

The main features of the invention will become more apparent from the following detailed description of a preferred, non-limiting embodiment, illustrated purely by way of example in the accompanying drawings, in which:

FIG. 1 is a perspective view, with some parts cut away to better illustrate others, of a machine for preparing and extracting a hot beverage according to the invention;

FIG. 2 is a top plan view of the machine of FIG. 1;

FIG. 3 is a top plan view, with some parts in cross section and others cut away, of the machine of the preceding drawing in a configuration for receiving and supporting the capsule by supporting arms;

FIG. 4 is a top plan view, with some parts in cross section and others cut away, of the machine of the preceding drawing in a configuration of expulsion of a used capsule;

FIGS. 5 and 6 show a second movable extraction unit of the machine of the preceding drawings with a pair of arms in a first operating position for supporting the capsule and, respectively, in a second operating position for releasing the capsule; FIG. 5 is a top plan view and FIG. 6 is a rear perspective view.

### DETAILED DESCRIPTION OF PREFERRED EMBODIMENTS OF THE INVENTION

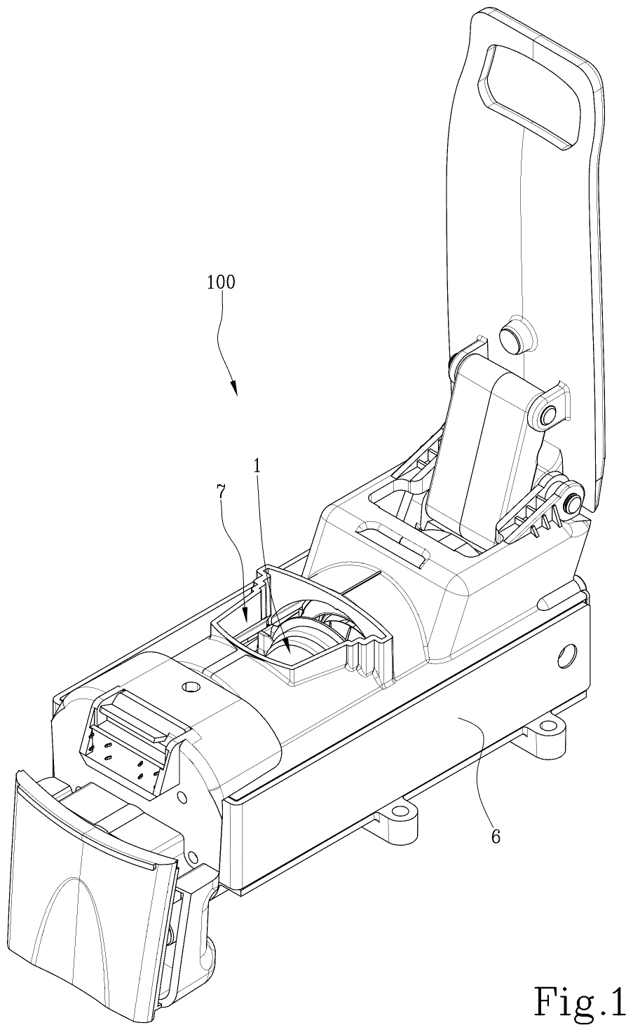

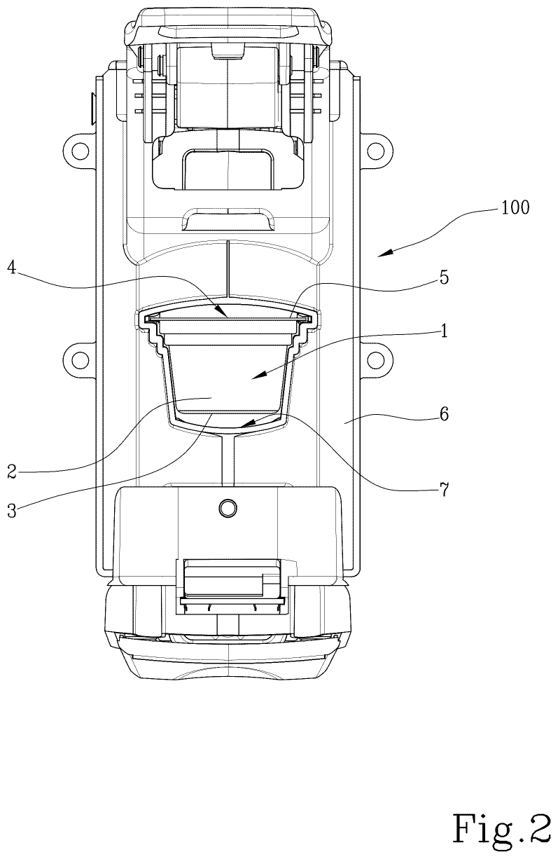

With reference to the accompanying drawings, in particular FIGS. 1 and 2, the machine according to the invention, labelled 100 in its entirety, is used with single capsules, preferably of the single-dose type, from which the hot beverage is extracted (such as coffee, tea, milk, camomile and similar beverages) by extracting the product with pressurised hot fluid.

The capsule 1 which can be used in the machine 100 basically comprises a capsule body 2, forming a chamber, having a bottom 3 and an upper opening 4 delimited by an annular collar 5 protruding transversally relative to the capsule body 2.

A sheet for sealing the chamber (not illustrated) is positioned on the opening 4 and the collar 5.

The chamber houses at least one dose of product.

FIGS. 1 and 2 illustrate a part of the machine for preparing and extracting a hot beverage from the capsule 1, that is to say, the operating parts of relevance for the invention.

The machine 100 comprises a load-bearing frame 6 having an inlet opening 7 for the capsule 1.

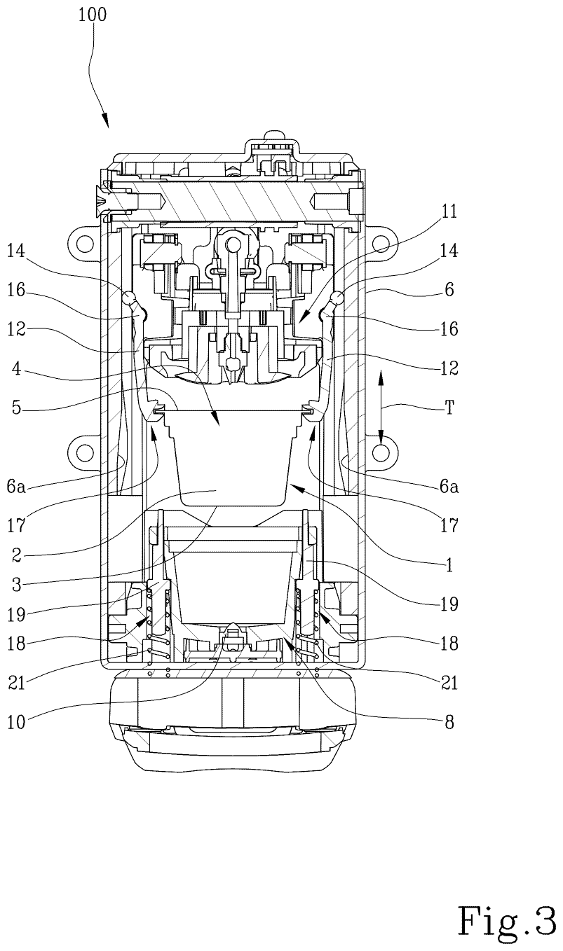

The frame 6 also comprises tracks 6a with cam profiles (see FIG. 3).

Moreover, the machine 100 comprises a first fixed extraction unit 8 associated with the frame 6, comprising a matching housing 9 for the capsule 1 and means 10 for perforating and passage of the mixture, to obtain the extraction of the beverage.

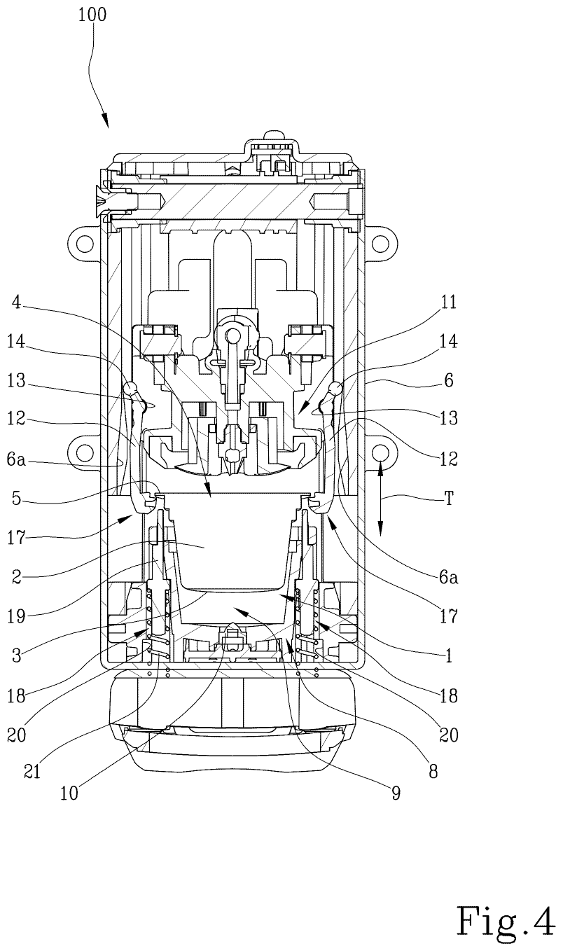

The machine 100 also comprises a second movable extraction unit 11, positioned inside the frame 6, and movable inside the frame 6 along a linear trajectory T, in both directions, between
a first non-operating end position away from the first fixed extraction unit 8 (FIG. 3), wherein the second movable extraction unit 11 is positioned close to the inlet opening 7, and
a second operating end position (FIG. 4) wherein the second movable extraction unit 11 is moved towards the first fixed extraction unit 8 in such a way as to move the capsule 1 from an inlet position to a position for insertion in the housing 9 of the first fixed unit 8 for extracting the beverage by feeding a pressurised hot fluid.

The machine 100 also comprises (see FIGS. 3 to 6) a pair of supporting arms 12 interposed between the second movable extraction unit 11 and the frame 6.

The pair of arms 12 is movable with the second movable extraction unit 11 and along the corresponding tracks 6a with cam profiles acting on the respective arms 12.

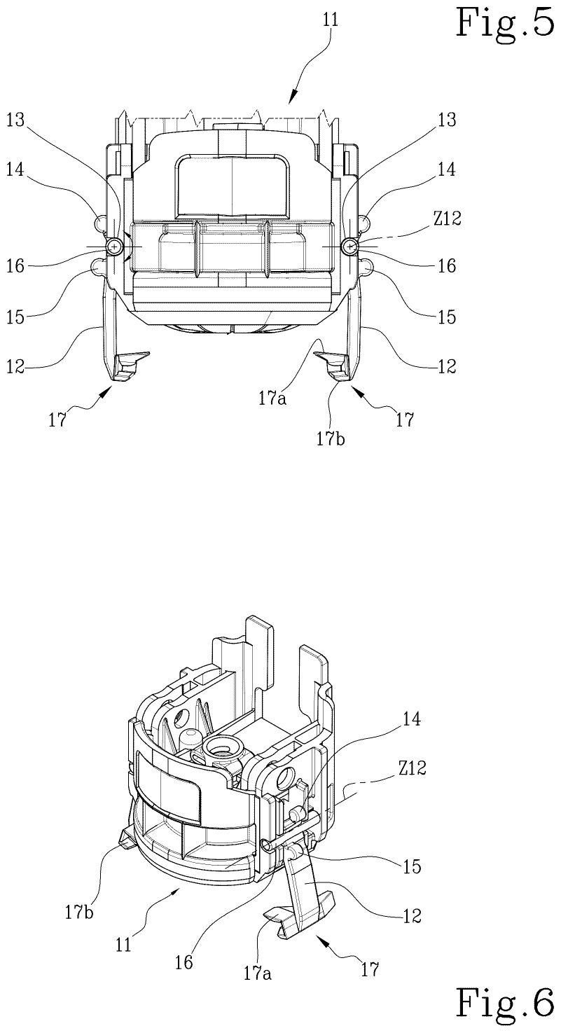

The cam profiles are made on the tracks 6a and are configured to allow the arms 12 to move from:
a first close-together operating position configured to support the capsule 1 entering (FIGS. 3 and 5), in the first non-operating position of the second movable extraction unit 11, to
a configuration for releasing from the capsule 1 (FIGS. 4 and 6), in a relative second far operating position, in the second operating position of the second movable extraction unit 11.

As illustrated (see FIGS. 3 to 6), each arm 12 is articulated, in a relative articulation zone, in a matching seat 13 made directly on the second movable extraction unit 11.

Each articulation zone of each arm 12 is provided with a pin 16 for constraining in the corresponding seat 13 in such a way as to define a pivot and rotation axis Z12 for the respective arm 12;

Each pin 16 is provided, on both sides, with two different contact heads 14, 15 protruding from the second movable extraction unit 11 and configured to interact, through their rotation about the axis Z12 with tracks 6a having cam profiles and made on the frame 6 to move each arm 12 between the first and second operating positions, and vice versa, during the movement of the second movable extraction unit 11.

In other words, each arm is pivoted directly to the second movable extraction unit and is provided with two “desmodromic” heads which are able to obtain the movement, by means of their rotation about the pivot axis, of the arms in the operating positions.

Preferably, each arm 12 has the articulation zone, located at one end of each arm 12, consisting of the pin 16 housed in the matching seat 13 (in this case and purely by way of an example U-shaped) formed in the second movable extraction unit 11.

In this way, each arm 12 can move only by means of a rotation about its axis Z12.

On both sides of the pin 16 there are the contact heads 14 and 15 which are angularly diverging from each other relative to the articulation pin 16, that is to say, axially spaced from each other from the pin 16 in such a way as to interact in the front in sliding contact with the cam tracks 6a.

In light of this, a first distal contact head 14 has a cylindrical shape obtained at the end of a lever made on the corresponding arm 12 for the front sliding contact with the cam tracks 6a.

The lever is inclined relative to the linear trajectory T in such a way as to allow the first contact head 14 to protrude towards the tracks 6a having the cam profiles.

In light of this, the second proximal contact head 15, has a cylindrical protruding shape made on the corresponding arm 12 and on the opposite side of the axis Z12 of articulation relative to the first contact head 14 and is configured to obtain the front sliding contact with the cam tracks 6a.

The first and second heads 14 and 15 are positioned at different heights relative to each other in such a way as to intercept different cam profiles obtained on tracks 6a superposed on each other.

Again as illustrated, each arm 12 has a free operating end provided with a fork 17 positioned transversally relative to the extension of the corresponding arm 12 and facing towards the other fork 17 of the other arm 12 and configured to support the capsule 1 at a relative zone defined by its collar 5 (see FIG. 3).

It should be noted that a first branch 17a defining each fork 17 has a length greater than the length of the second branch 17b.

In light of this, the first longer branch 17a is configured to intercept a portion of the collar 5 of a used capsule 1, at the passage from the second far operating position to the first near operating position, in such a way as to allow a complete escape of the used capsule 1 from the housing 9 of the first fixed extraction unit 8 (see also FIG. 4).

Preferably, the first fixed extraction unit 8 comprises a device 18 for aligning the capsule 1 entering and pre-expulsion of the used capsule 1 configured for:
correctly aligning the capsule 1 entering the housing 9 and
extracting at least partly the used capsule 1 from the housing 9 to allow, after the pre-expulsion, the intercepting of the collar 5 of the used capsule 1 by the supporting arms 12 to obtain a complete expulsion of the used capsule 1 from the housing 9, at the passage of the second movable extraction unit 11 from the second operating position to the first non-operating position.

It should be noted that the aligning and pre-expulsion device 18 comprises at least one element 19 movable parallel to the linear trajectory T of movement of the second extraction unit 11 movable between:
a first advanced non-operating position waiting for the capsule 1 entering, wherein the element 19 protrudes from a seat 20 of the first fixed extraction unit 8;
a second withdrawn position for aligning the capsule 1 entering, wherein the element 19 is housed inside the seat 20 of the first fixed extraction unit 8, at the housing of the capsule 1, that is to say, due to the pushing action of the capsule 1 inserted in the housing 9, and
a further third advanced position, wherein the element 19 protrudes partly from the seat 20 of the first fixed extraction unit 8 which is able to pre-expel the used capsule 1. Preferably, the aligning/pre-expulsion device 18 comprises two elements 19 positioned diametrically opposite each other along the housing (9) of the capsule 1 of the first fixed extraction unit 8 and configured to intercept, in two different points, the collar 5 of the capsule 1.

Each element 19 may consist of a rigid rod having the free head end configured for the spot contact with a zone of the collar of the capsule 1.

Moreover, the aligning/pre-expulsion device 18 comprises an elastic element 21 interposed between one end of each element 19 and the bottom of the seat 20 in which the elastic element 19 is housed.

Each elastic element 21 is configured to keep the element 19 in the first advanced position in the absence of the capsule 1 in the housing 9 of the first fixed extraction unit 8 and to pre-expel the used capsule 1 in the third advanced position.

The machine structured in this way allows the capsule to be received from the infeed of the frame with support of the capsule on the forks of the arms (FIG. 3).

At this point, the second movable extraction unit is moved towards the first fixed extraction unit until the capsule is completely inserted into the housing.

During the movement of the second unit, the arms are controlled by the heads interacting with the cam profiles of the tracks and, close to the first fixed extraction unit, the arms open to free the collar of the capsule and position itself outside the housing.

After extraction of the mixture or beverage, the second movable extraction unit starts a withdrawal movement, together with the arms, and away from the first fixed extraction unit.

After the withdrawal of the second movable extraction unit, there is a partial outlet of the capsule from the housing of the first fixed extraction unit which allows the branch of greater length of the fork of each arm (which is returning or has already partly returned to the first supporting position with the forks towards each other) to intercept the collar of the used capsule and pull it towards a discharge chamber (not illustrated) of the used capsules.

It should be noted that, during housing of the capsule, the aligning/pre-extraction elements intercept frontally two different zones of the collar of the capsule (so as to allow correct centring of the capsule in the housing) and withdraw inside their seat in the first unit with relative compression of the respective elastic element.

Moreover, during the moving away of the second movable extraction unit the aligning/pre-extraction elements, under the action of the elastic element, push on the collar of the used capsule to allow a pre-expulsion of the used capsule to allow a correct intercepting of the collar of the used capsule by the branches of greater length of the forks of the arms.

The preset aims are achieved with a machine structured in this way thanks to the system for articulation of the arms directly on the second unit, the presence of control cam follower heads which are able to control the arms with extreme precision and reducing the friction in combination with cam tracks made on the frame.

This structure of the arms, combined with the positioning/pre-extraction elements, guarantees a correct discharge of the used capsules.

All these functions listed above are obtained with limited operating components on the machine and with extremely reliable and precise construction structures.

1. A machine for preparing and extracting a hot beverage from a capsule; the machine comprising:
a load-bearing frame having an inlet opening for the capsule;
a first fixed extraction unit associated with the frame and comprising a matching housing for the capsule and configured to obtain the extraction of the beverage;
a second movable extraction unit, positioned inside the frame, and movable inside the frame along a linear trajectory, in both directions, between a first non-operating wherein the second movable extraction unit is positioned close to the inlet opening, and a second operating end position wherein the second movable extraction unit is moved towards the first fixed extraction unit to move the capsule inside the housing;
a pair of supporting arms interposed between the second movable extraction unit and the frame; said pair of arms being movable with the second movable extraction unit and along the frame in such a way as to move from a first near operating end position and configured to support the capsule entering, in the first non-operating position of the second movable extraction unit, to a released configuration from the capsule, in a relative second far operating end position, in the second operating position of the second movable extraction unit; characterised in that each arm is articulated, in a relative articulation zone, in a matching seat made directly on the second movable extraction unit; each articulation zone being provided with a pin for constraining in the corresponding seat in such a way as to define a pivot and rotation axis for the respective arm; each pin being provided, bilaterally, with two different contact heads protruding from the second movable extraction unit and configured to interact, through tear rotation about the axis, with tracks having cam profiles and made on the frame to move each arm between the first and second operating positions, and vice versa, during the movement of the second movable extraction unit.

2. The machine according to claim 1, wherein each arm has the articulation zone, located at one end of each arm, comprising a pin housed in the seat of the second movable extraction unit; on both sides of the pin there are the contact heads which are angularly diverging from each other relative to the articulation pin, that is to say, axially spaced from each other from the pin in such a way as to interact in the front in sliding contact with the cam tracks.

3. The machine according to claim 1, wherein a first distal contact head has a cylindrical shape obtained at the end of a lever made on the corresponding arm; the lever being inclined relative to the linear trajectory in such a way as to allow the first head to protrude towards the tracks having the cam profiles.

4. The machine according to claim 1, wherein a second proximal contact head has a cylindrical projecting shape made directly on the corresponding arm and on the opposite side of the axis of articulation relative to the first contact head.

5. The machine according to claim 1, wherein each arm has a free operating end provided with a fork positioned transversally relative to the extension of the corresponding arm and facing towards the other fork of the other arm and configured to support the capsule at a relative area defined by a collar of the capsule.

6. The machine according to claim 5, wherein a first branch defining the fork has a length greater than the length of the second branch; the first longer branch being configured to intercept a portion of the collar of a used capsule, at the passage from the second far operating position to the first near operating position, in such a way as to allow a complete escape of the used capsule from the housing of the first fixed extraction unit.

7. The machine according to claim 1, wherein the first fixed extraction unit comprises a device for aligning the capsule entering and pre-expulsion of a used capsule configured, respectively, to align the incoming capsule and to ensure an at least partial extraction of the used capsule from the housing and in such a way as to allow, after pre-expulsion, interception of a collar of the used capsule by the supporting arms to obtain a complete expulsion of the used capsule from the housing, at the passage of the second movable extraction unit from the second operating position to the first non-operating position.

8. The machine according to claim 7, wherein the pre-expulsion device comprises at least one element movable parallel to the linear trajectory of movement of the second movable extraction unit between:
a first advanced non-operating position waiting for the capsule entering, wherein the element protrudes from a seat of the first fixed extraction unit;
a second withdrawn position for aligning the capsule entering, wherein the element is housed inside the seat of the first fixed extraction unit, at the housing of the capsule, that is to say, due to the pushing action of the capsule inserted in the housing, and
a further third advanced position, wherein the element protrudes partly from the seat of the first fixed extraction unit which is able to pre-expel the used capsule.

9. The machine according to claim 7, wherein the aligning/pre-expulsion device comprises two elements positioned diametrically opposite each other along the housing of the capsule of the first fixed extraction unit and configured to intercept, in two different points, the used capsule.

10. The machine according to claim 8, wherein the aligning/pre-expulsion device comprises an elastic element interposed between one end of each element and the bottom of the seat in which the elastic element is housed; each elastic element being configured to keep the element in the first advanced position in the absence of the capsule in the housing of the first fixed extraction unit and to pre-expel the used capsule in the third advanced position.
